(19) United States
(12) Patent Application Publication
(10) Pub. No.: US 2011/0141736 A1
(43) Pub. Date: Jun. 16, 2011

(54) LED panel

(76) Inventors: Yun-Chen Lin, Taipei (TW); Wen Yi Huang, Taipei (TW); Fusan Chen, Taipei (TW); Chia Chi Chen, Taipei (TW); Chin Wei Chen, Taipei (TW); Wei Jane Lin, Taipei (TW)

(21) Appl. No.: 12/637,475

(22) Filed: Dec. 14, 2009

(51) Int. Cl. F21S 4/00; F21V 5/04

(52) U.S. Cl. 362/240; 362/249.02

(57) ABSTRACT

A rectangular LED panel includes a transparent cover plate comprising a flanged frame having two recesses on each edge and a plurality of projections on a rear surface; a rectangular substrate comprising a plurality of through holes, a plurality of LED elements on a front surface, a plurality of electrically connected ICs on a rear surface, and four sets of first and second electrical terminals electrically connected to the ICs wherein the ICs are electrically connected to the LED elements; and a base plate comprising four sets of two cavities. The base plate is secured to the rear surface of the substrate and the substrate is secured to the rear surface of the cover plate with the projections being inserted through the through holes to urge against the base plate, and each of the first and second electrical terminals being disposed adjacent to both the recess and cavity.

### BACKGROUND OF THE INVENTION

1. Field of Invention

The invention relates to LED lighting devices and more particularly to an LED panel with improved characteristics including being adapted to assemble with other same LED panels to form a large LED panel light source.

2. Description of Related Art

LEDs (light-emitting diodes) are advantageous over incandescent lamps and fluorescent lamps because LEDs have many advantages including lower energy consumption, longer lifetime, improved robustness, smaller size, faster switching, and greater durability.

LED panel light sources are gaining popularity in recent years. Conventionally, an LED panel light source is made by assembling many components including LED panels at site. That is, it is not manufactured at factory. This type of customized LED panel light source inevitably increases the manufacturing cost.

There is an improved type of prefabricated LED panel light source commercially available. However, they are typically costly to manufacture, trouble-prone, and unreliable in use. Thus, the need for improvement still exists.

### SUMMARY OF THE INVENTION

It is therefore one object of the invention to provide an LED panel adapted to assemble with other same LED panels to form a large LED panel light source.

The above and other objects, features and advantages of the invention will become apparent from the following detailed description taken with the accompanying drawings.

### BRIEF DESCRIPTION OF THE DRAWINGS

FIG. 1 is an exploded view of a first preferred embodiment of LED panel according to the invention;

FIG. 2 is a front view of the assembled LED panel;

FIG. 3 is a sectional view taken along line A-A of FIG. 2;

FIG. 4 is a sectional view taken along line B-B of FIG. 2;

FIG. 5 is a front view of a large LED panel light source formed by assembling four LED panels;

FIG. 6 is a sectional view taken along line C-C of FIG. 5;

FIG. 7 is a sectional view taken along line D-D of FIG. 5;

FIG. 8 is an exploded view of a second preferred embodiment of LED panel according to the invention;

FIG. 9 is a front view of the assembled LED panel; and

FIG. 10 is a sectional view taken along line E-E of FIG. 9.

### DETAILED DESCRIPTION OF THE INVENTION

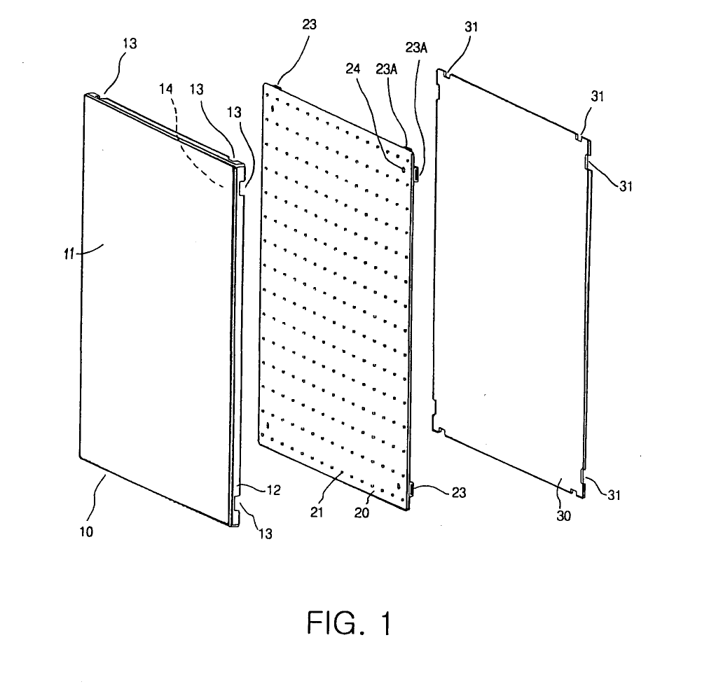

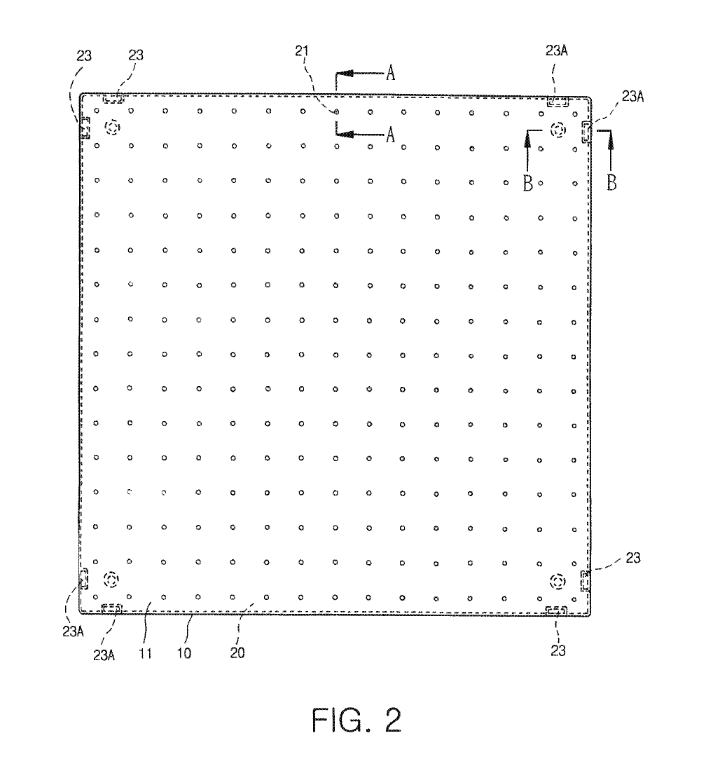

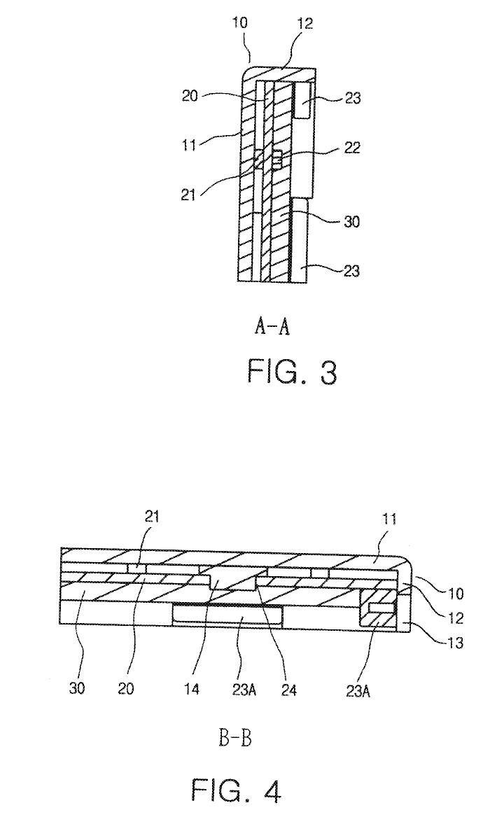

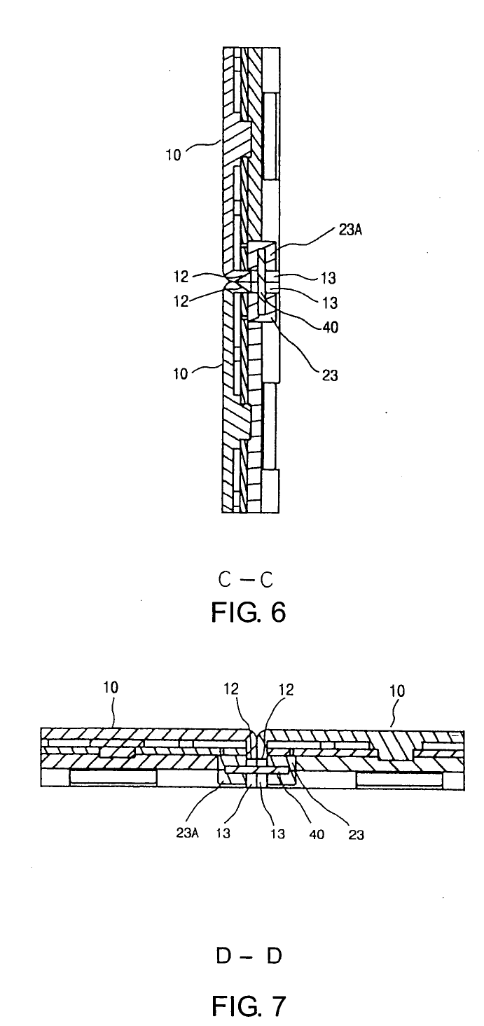

Referring to FIGS. 1 to 7, a rectangular LED panel in accordance with a first preferred embodiment of the invention comprises the following components as discussed in detail below.

A cover plate 10 comprises a rectangular flanged frame 12 having two recesses 13 on each of four edges, an optically transmissive member 11 is set in the frame 12, and four corner projections 14 on the back of the optically transmissive member 11.

A rectangular substrate 20 comprises four corner through holes 24, a plurality of LED elements 21 on a front surface arranged in rows facing the optically transmissive member 11, a plurality of ICs (integrated circuits) 22 on a rear surface arranged in rows and being electrically connected together, and four sets of first and second electrical terminals 23 and 23A in which the first and second electrical terminals 23 and 23A of the same set are formed on each edge with the first electrical terminal 23 being provided proximate to one corner and the second electrical terminal 23A being provided proximate to the other adjacent corner. Each of the first and second electrical terminals 23 and 23A is electrically connected to the IC 22.

A rectangular base plate 30 comprises four sets of two cavities 31 in which the cavities 31 of the same set are formed on each edge with one cavity 31 being provided proximate to one corner and the other cavity 31 being provided proximate to the other adjacent corner. In an assembled state of the cover plate 10, the substrate 20, and the base plate 30, the base plate 30 is fitted into the rear surface of the substrate 20 and the substrate 20 is fitted into the rear surface of the cover plate 10 respectively. Also, the projections 14 are complementarily fitted through the through holes 24 to urge against the front surface of the base plate 30, each of the first and second electrical terminals 23 and 23A is disposed adjacent to the recess 13, and the ICs 22 are disposed rearward of the LED elements 21 in a one-to-one corresponding relationship with each IC 22 being electrically connected to the LED element 21.

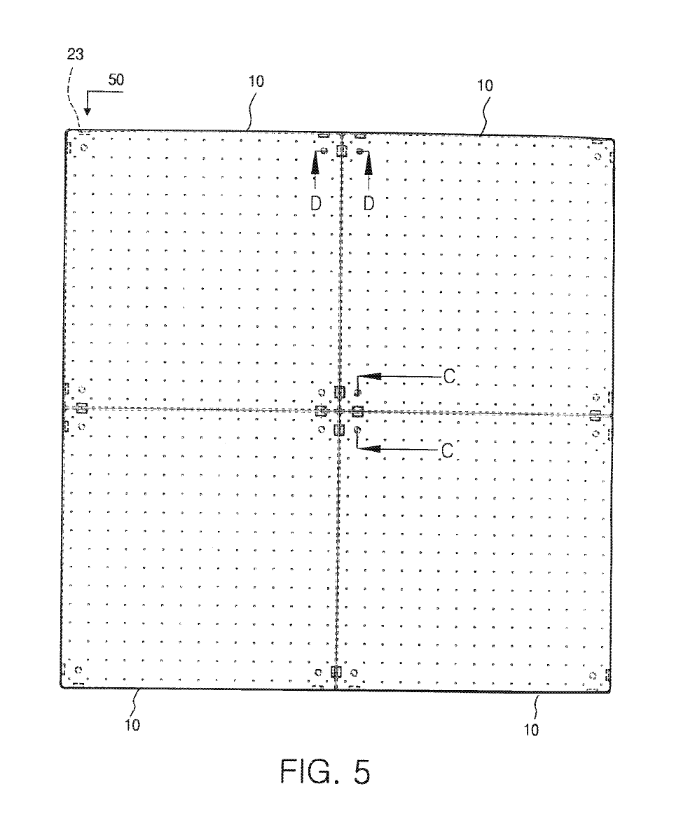

As shown in FIGS. 5 to 7 specifically, four LED panels are arranged together. Next, a plurality of conductors 40 are employed each to interconnect the first electrical terminal 23 of one LED panel and the second electrical terminal 23A of another adjacent LED panel. As a result, a large LED panel light source 50 is assembled. Any one of the first and second electrical terminals 23 and 23A can be employed to electrically connect to an external power source (not shown) so that the large LED panel light source 50 can be lit when energized.

Preferably, the base plate 30 is formed of a material being good in heat dissipation so that high heat generated by the LED elements 21 and the ICs 22 in use can be effectively removed.

Preferably, the LED elements 21 are either mono light sources or light sources comprised of LEDs of different colors.

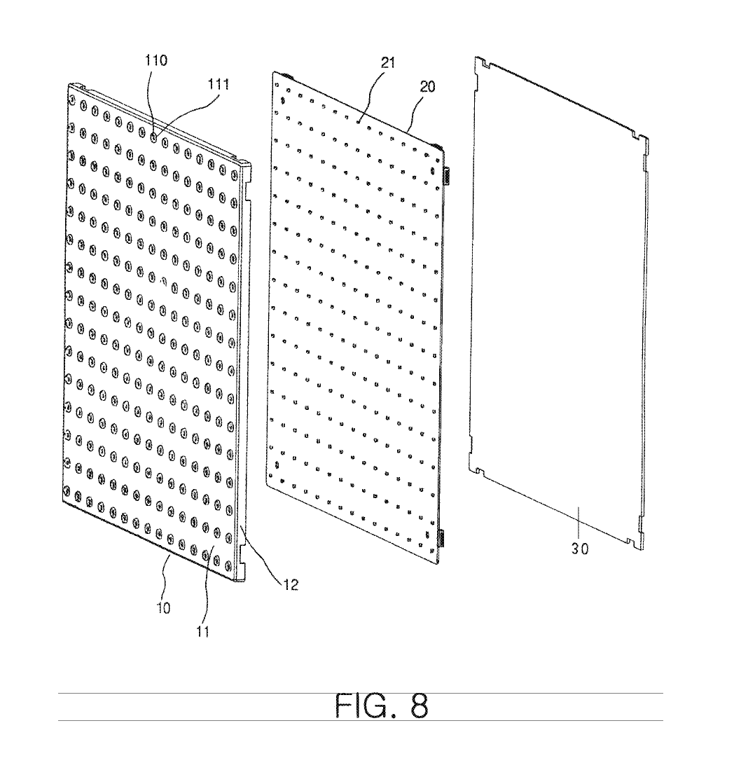

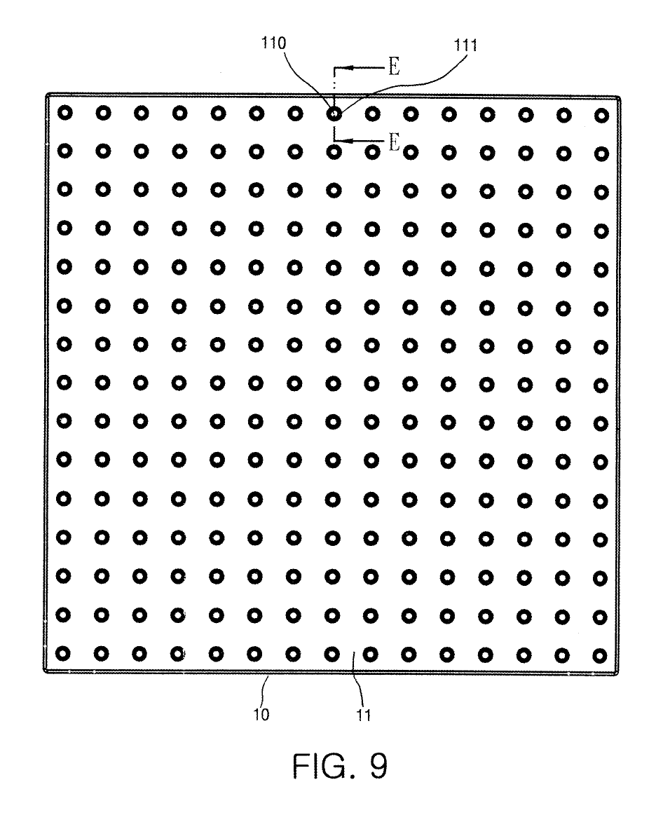

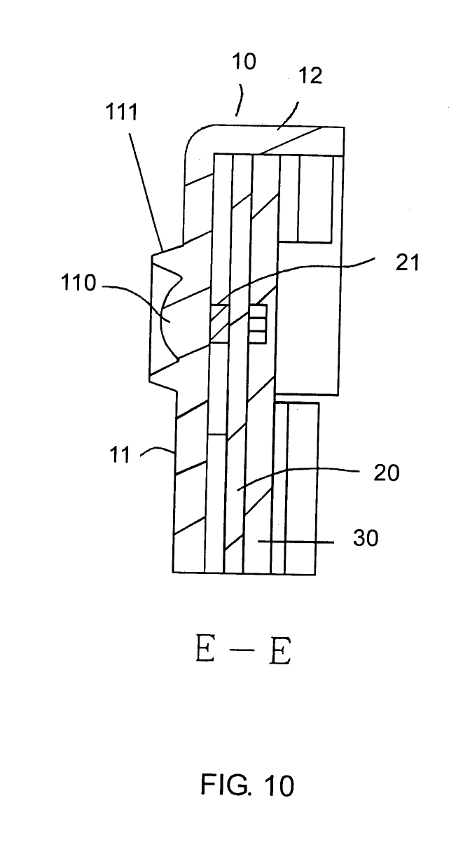

Referring to FIGS. 8 to 10, an LED panel in accordance with a second preferred embodiment of the invention is shown. The characteristics of the second preferred embodiment are detailed below. A plurality of plano-convex lens 110 are formed on the LED elements 21 in a one-to-one corresponding relationship. The lens 110 can spread rays of light emitted by the LED element 21 passing through it. Further, an annular wall 111 is formed around each lens 110. The wall 111 has a depth greater than that of the lens 21. Hence, the wall 111 can deflect light so as to direct more rays of light forward (i.e., bringing together light).

The invention has the following advantages. Such assembly can be done in factory. Also, a plurality of LED panels can be assembled to form a large LED panel light source 50 depending on applications.

While the invention herein disclosed has been described by means of specific embodiments, numerous modifications and variations could be made thereto by those skilled in the art without departing from the scope and spirit of the invention set forth in the claims.

What is claimed is:

1. An LED (light-emitting diodes) panel comprising:
a transparent cover plate comprising a rectangular flanged frame having two recesses on each of four edges and a plurality of projections on a rear surface;
a rectangular substrate comprising a plurality of through holes, a plurality of LED elements on a front surface, a plurality of electrically connected ICs (integrated circuits) on a rear surface, and four sets of first and second electrical terminals electrically connected to the ICs wherein the ICs are electrically connected to the LED elements; and
a rectangular base plate comprising four sets of two cavities,
wherein the base plate is secured to the rear surface of the substrate and the substrate is secured to the rear surface of the cover plate with the projections being complementarily inserted through the through holes to urge against the base plate, and each of the first and second electrical terminals being disposed adjacent to both the recess and cavity.

2. The LED panel of claim 1, further comprising a conductor for electrically connecting either (i) the first electrical terminal of a first LED panel and the second electrical terminal of a second LED panel or (ii) the second electrical terminal of the first LED panel and the first electrical terminal of the second LED panel.

3. The LED panel of claim 1, further comprising a plurality of plano-convex lens each on the LED element, and a plurality of annular walls each around the plano-convex lens.

4. The LED panel of claim 3, wherein the wall has a depth greater than that of the plano-convex lens.
